(19) United States
(12) Patent Application Publication
(10) Pub. No.: US 2008/0100976 A1
(43) Pub. Date: May 1, 2008

(54) Limiting energy in wiring faults combined upstream and downstream protection

(75) Inventors: Kevin M. Huczko, New Florence, PA (US); Roger D. Huczko, Pittsburgh, PA (US); Stanley J. Pisarski, Portage, PA (US); Brett M. Yeager, Blairsville, PA (US)

Correspondence Address: Ansel M. Schwartz;Attorney at Law, Suite 304, 201 N. Craig Street, Pittsburgh, PA, 15213, US

(73) Assignee: KH Controls, Inc.

(21) Appl. No.: 11/880,691

(22) Filed: Jul. 24, 2007

Related U.S. Application Data
(60) Provisional application No. 60/833,087, filed on Jul. 25, 2006.

(51) Int. Cl. H02H 3/38

(52) U.S. Cl. 361/79

(57) ABSTRACT

An intrinsically safe system in a hazardous atmosphere includes a power supply. The system includes a plurality of load devices. The system includes wiring in communication with the power supply and the load devices that is located in the hazardous atmosphere. The system includes a protector connected to the wiring which provides upstream protection by detecting dropping input terminal voltage and provides downstream protection by limiting output current. A method for providing power in a hazardous atmosphere includes the steps of placing wiring in communication with a power supply and a plurality of load devices to the hazardous atmosphere. There is the step of protecting the wiring with a protector connected to the wiring which provides upstream protection by detecting dropping input terminal voltage and provides downstream protection by limiting output current.

### FIELD OF THE INVENTION

The present invention is related to an intrinsically safe electrical system with respect to a hazardous atmosphere. More specifically, the present invention is related to an intrinsically safe electrical system with respect to a hazardous atmosphere which provides upstream protection and provides downstream protection.

### BACKGROUND OF THE INVENTION

The present invention limits the energy delivered to a fault in the electrical circuitry feeding an electrical load. This feature is of general value in many electrical systems and of great value in electrical systems that deliver power in hazardous atmospheres. The fault and its associated energy could become a source of ignition and result in a fire or explosion.

Typically, electrical equipment, components and systems that demonstrate the ability to avoid such an ignition are classified as intrinsically safe for a specific hazard.

A significant market for this solution is in the underground coal mining industry. In this industry, intrinsic safety is specifically defined in many publications. In the United States intrinsic safety is referenced by Title 30 of the Code of Federal Regulations Part 18 by the US Department of Labor, Mine Safety and Health Administration (MSHA). Internationally intrinsic safety is referenced in EN50020, IEC 60079-11 and many other international standards.

There are many examples of providing intrinsic safety protection by employing limiting means at the power source. This technique provides downstream protection for the load devices and interconnect wiring. The examples include Cawley U.S. Pat. No. 4,438,473, Mukli U.S. Pat. No. 4,638,396, Bruch U.S. Pat. No. 4,831,484, Geuns U.S. Pat. No. 5,050,060 and Huczko U.S. Pat. No. 5,694,283.

In addition, Lytollis U.S. Pat. No. 6,751,076 employs a technique to provide intrinsic safety by means of a device located at the load to implement upstream protection for the wiring feeding the load.

It is important to note the prior art or common industry practice related specifically to inductive load devices. Load devices with inductive characteristics are very common. They include relays, actuators, solenoids, etc. The well established technique for confining the energy trapped in the device is to apply a free wheeling diode. Upon disconnecting the device through either normal means or a damaged connection, the energy in the device is contained or “Free Wheels” within the load device. This technique is commonly accepted in the areas of intrinsic safety and general applications for inductive load devices.

One type of wiring fault that is a potential ignition source is illustrated in FIG. 1. The fault 4 could be a broken wire or conductor in the interconnection 3 between the power source 1 and the load 2. If electrical current is flowing through the conductor as the conductor breaks an electrical arc 4 is created. This arc 4 is a potential ignition source. The ignition potential or risk is increased if the wiring 3 is located in a hazardous atmosphere.

The arc energy or ignition potential is greatly increased if the load device exhibits characteristics to maintain the flow of current into the fault as shown in FIG. 2. For example, an inductive load similar to a solenoid has this characteristic. The inductance of the load will mimic a constant current source 6. It will act to maintain the flow of current from the power source 5 through the interconnect wiring 7 and into the fault 8 to for the duration of the fault. This will increase the probability of ignition at a given level of current or it will greatly limit the maximum “Safe” level of current to insure that an ignition can not occur.

It is commonly accepted in many industries, including areas of intrinsic safety, that the use of a freewheeling diode can isolate the energy trapped in an inductive load when the path from the source is interrupted. The application of a freewheeling diode is illustrated in FIG. 3. The freewheeling diode 14 provides a path for the current trapped in the inductive load 13 when the path from the source 9 is opened. Typically, the path would be opened by a switch or control device to de-energize the load. The path or interconnect wiring 10 might also be disrupted by an in line fault 12.

A simple analysis of the circuit reveals that the current will only transfer from the fault 12 into the freewheeling diode 14 if and when the voltage across the fault 12 reaches the output voltage of the power source 9 plus the forward voltage drop of the freewheeling diode 14. Typically, this transfer occurs when the normal source path is opened. This will occur for example when the load is turned off by opening the current delivery path at the source 9. Ideally, this transfer will also occur very fast in the event of the inline fault 12 shown in FIG. 3. Very fast infers a time duration much shorter than the time required to deliver sufficient energy to create an ignition resulting in an explosion or fire.

The diagrams in FIG. 4 illustrate the ideal transfer of current in the circuit of FIG. 3 from the arcing fault 12 into the freewheeling diode 14. Given an arcing fault 12 that occurs at time t41, the arc voltage shown in FIG. 4a will appear at time t41 and increase abruptly to the level of source voltage plus the forward drop of the freewheeling diode at time t42. The arc current shown in FIG. 4b will remain constant at the level of load current for the time period spanning time t41 to time t42. At time t42 the freewheeling diode 14 becomes forward biased and accepts the transfer of current as shown in FIG. 4c. The power delivered to the arc, arc voltage FIG. 4a multiplied by arc current FIG. 4b is illustrated in FIG. 4d. This transfer process relies on forward biasing the diode. It should be noted that as the transfer of current from the arc into the diode begins the negative impedance characteristic of the arc accelerates the transfer. As the current in the arc starts to decrease, the arc voltage tends to increase and thus transfers the current more quickly.

The preceding simple assessment of the arc overlooks an important electrical characteristic of the arc. In fact, it is well known through electrical arc welding and other plasma arc processes that the arc may have a voltage limiting characteristic. The actual arc voltage is related to many factors including the geometry of the electrical points feeding the arc, the contact material, temperature, the gas composition of the atmosphere, etc. Therefore, there is no predetermined precise voltage for the arc due to a fault. In fact, the voltage may fluctuate widely due to changes in the conditions from the burning arc. The arc voltage relative to the power source voltage is indeterminate. The previous example of current transfer in FIG. 4 relies on an arc voltage which attempts to exceed the power source voltage immediately.

The diagrams in FIG. 5 illustrate a current transfer for the circuit of FIG. 3 given an arc voltage that could be below the level of the source voltage for some period of time. Given an arcing fault 12 that occurs at time t51, the arc voltage shown in FIG. 5a will appear at time t51 and increase abruptly. However, due to the characteristic of the arc the voltage drop of the arc will not reach or exceed the level of source voltage for some period of time. At an arbitrary point in time, time t52, the arc voltage FIG. 5a exceeds the level of the source voltage 9 plus the forward drop of the freewheeling diode 14. The freewheeling diode current is illustrated in FIG. 5c. Note that no current diverts through the freewheeling diode 14 until it becomes forward biased at time t52. The forward bias condition occurs only if and when the voltage across the arc exceeds the source voltage plus the diode forward drop voltage. Throughout the time period spanning t51 to t52, the arc current FIG. 5b remains constant. The power delivered to the arc is illustrated in FIG. 5d. The resulting energy, integration of power over time, delivered to the arc is substantially greater than initially expected. The freewheeling diode 14 does not guarantee that the current is quickly transferred from the arc 12.

This is a significant observation. It means that in the circuit of FIG. 3, a freewheeling diode 14 cannot definitively contain the trapped energy of the inductive load 13 from feeding into the fault 12. In addition, current flow is maintained around the overall loop allowing the power source 9 to contribute added energy to the fault 12. Therefore, an inductive load 13 with freewheeling diode 14 must be considered carefully in any analysis or test for the ignition potential of a fault in the circuit 10 feeding the load 11. For test purposes to assess the ignition risk of a circuit, the actual device and wiring network must be included in the test. A non-inductive or resistive equivalent load may not be used.

### BRIEF SUMMARY OF THE INVENTION

The present invention pertains to an intrinsically safe system in a hazardous atmosphere. The system comprises a power supply. The system comprises a plurality of load devices. The system comprises wiring in communication with the power supply and the load devices that is located in the hazardous atmosphere. The system comprises an enhancement device connected to the wiring which provides upstream protection by detecting dropping input terminal voltage and provides downstream protection by limiting output current.

The present invention pertains to a method for providing power in a hazardous atmosphere. The method comprises the steps of placing wiring in communication with a power supply and a plurality of load devices to the hazardous atmosphere. There is the step of protecting the wiring with enhancement device connected to the wiring which provides upstream protection by detecting dropping input terminal voltage and provides downstream protection by limiting output current.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 is a diagram of Power Source, Load and Interconnect Wiring with Fault.

FIG. 2 is a diagram of Power Source, Current Source Load and Wiring Fault.

FIG. 3 is a diagram of Inductive Load with Freewheeling Diode.

FIGS. 4a-4d show waveforms for Ideal Current Transfer.

FIGS. 5a-5d show waveforms for Current Transfer with Limited Arc Voltage.

FIGS. 6a and 6b show waveforms for Input Voltage Drop.

FIG. 7 is a diagram of the Enhancement Device of the present invention.

FIGS. 8a-8e show waveforms for the Enhancement Device.

FIG. 9 is a diagram of Power Source, Inductive Load and Interconnect Wiring with Fault and Lumped Stray Inductance.

FIG. 10 is a diagram of Power Source, Inductive Load and Interconnect Wiring with Fault and Lumped Stray Inductance.

FIGS. 11a-11e show waveforms for Enhancement Device with Input Voltage Limiting Device in the Presence of Stray Inductance.

FIG. 12 is a diagram of Enhancement Device with Turn-On Delay.

FIG. 13a-13c show waveforms for Turn-On Delay Function.

FIG. 14 is a diagram of the Enhancement Device.

FIG. 15 is a diagram of a Segmented System with Enhancement Devices.

FIG. 16 is a functional block diagram of the Enhancement Device.

FIG. 17 is a detailed schematic of the Enhancement Device.

FIG. 18 is a block diagram of Redundant Implementation.

FIG. 19 is a diagram of Switch and Current Sense in Each Path.

FIG. 20 is a diagram with Bypass Ground Fault.

FIG. 21 is a functional block diagram of the Enhancement Device with and Current Sense in Each Path.

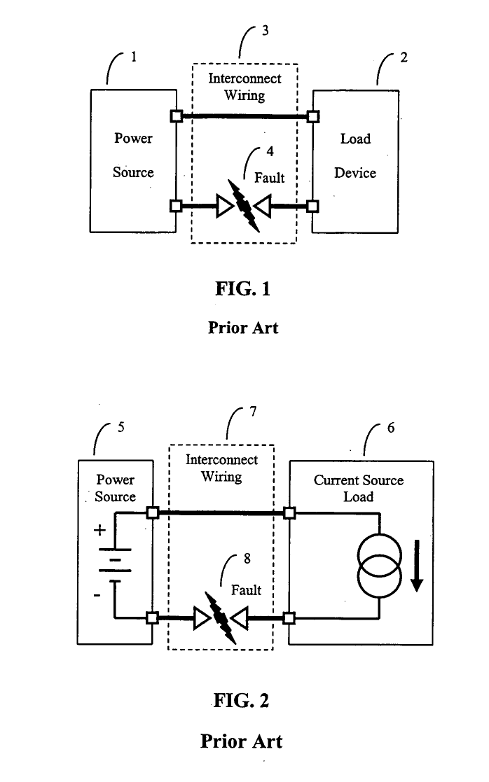

### DETAILED DESCRIPTION OF THE INVENTION

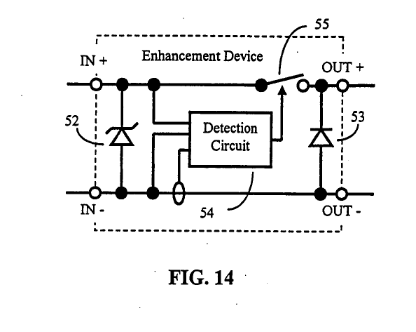

Referring now to the drawings wherein like reference numerals refer to similar or identical parts throughout the several views, and more specifically to FIGS. 14-16 thereof, there is shown an intrinsically safe system 100 in a hazardous atmosphere. The system 100 comprises a power supply 60. The system 100 comprises a plurality of load devices. The system 100 comprises wiring 59 in communication with the power supply 60 and the load devices 58 that is located in the hazardous atmosphere. The system 100 comprises enhancement device 56 connected to the wiring 59 which provides upstream protection by detecting dropping input terminal voltage to the enhancement device 56 and provides downstream protection by limiting output current from the enhancement device 56.

Preferably, the plurality of load devices 58 are arranged into segments, and the enhancement device 56 provides downstream protection to a specific segment by limiting output current from the enhancement device 56. The plurality of load devices 58 preferably incorporate freewheeling diodes to contain trapped inductive load energy.

Preferably, the enhancement device 56 includes an integral switch 83 to interrupt a current delivery path from the input terminals of the enhancement device 56 to the output terminals of the enhancement device 56. The switch 83 is preferably electronic. Preferably, the switch 83 is a MOSFET transistor. The switch 83 is preferably controlled in response to a combination of conditions including input terminal voltage to the enhancement device 56, output current delivered by the enhancement device 56 and internal logic power voltage levels.

Preferably, the switch 83 is inhibited from turning on if its internal logic power levels are above a predetermined level. The enhancement device 56 preferably includes a switch control circuit 89 that delays the turn on of the switch 83 at power up and after the switch 83 has been turned off in response to a fault condition. Preferably, the system 100 includes a voltage detector 85 to monitor input terminal voltage to the enhancement device 56 to observe a drop or dropping input terminal voltage, and in response, the enhancement device 56 interrupts the current delivery path to its output terminals. The voltage detector 85 is preferably adapted to maintain a detection level at a specified value below a nominal input terminal voltage of the enhancement device 56. The detection level is maintained in response to slowly changing input terminal voltage to the enhancement device 56.

Preferably, the enhancement device 56 includes a current level detector 86 to monitor the output current from the enhancement device 56 to observe a current that attempts to exceed a predetermined level, and in response, the enhancement device 56 interrupts the current delivery path to its output terminals. The system 100 preferably includes a second enhancement device 56 for redundancy. Preferably, the system 100 includes a third enhancement device 56 for triple redundancy.

The present invention pertains to a method for providing power in a hazardous atmosphere. The method comprises the steps of placing wiring 59 in communication with a power supply 60 and a plurality of load devices 58 to the hazardous atmosphere. There is the step of protecting the wiring 59 with an enhancement device 56 connected to the wiring 59 which provides upstream protection by detecting dropping input terminal voltage to the enhancement device 56 and provides downstream protection by limiting output current from the enhancement device 56. Preferably, the method includes the step of locating the enhancement device 56 inside a mine.

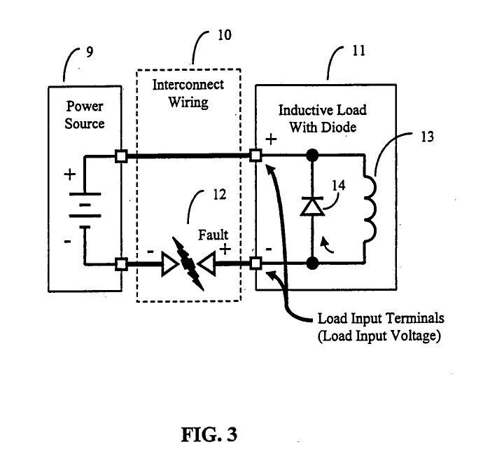

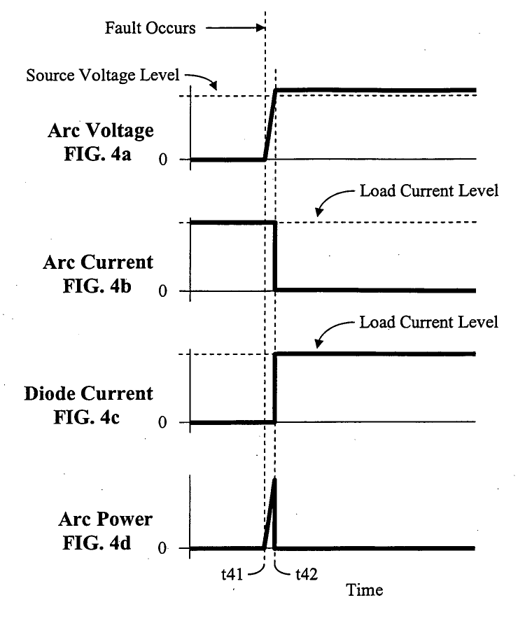

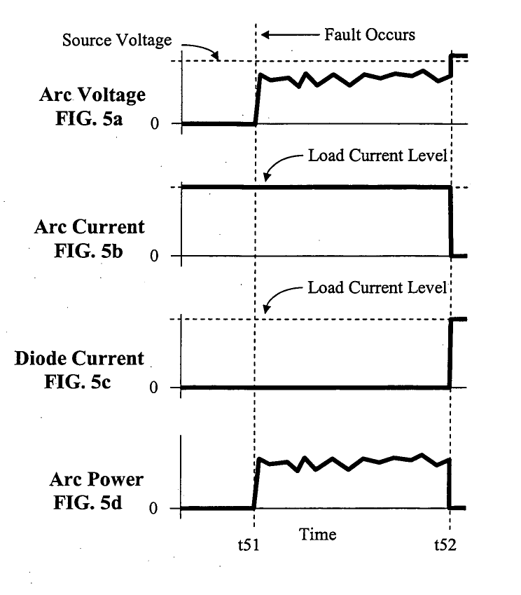

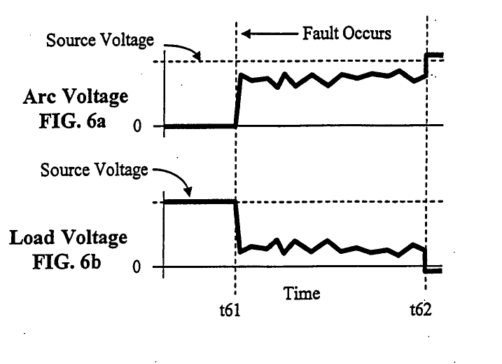

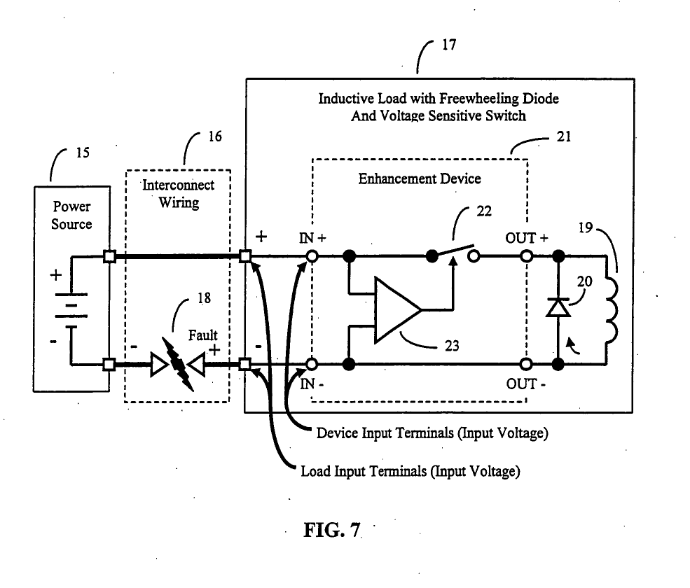

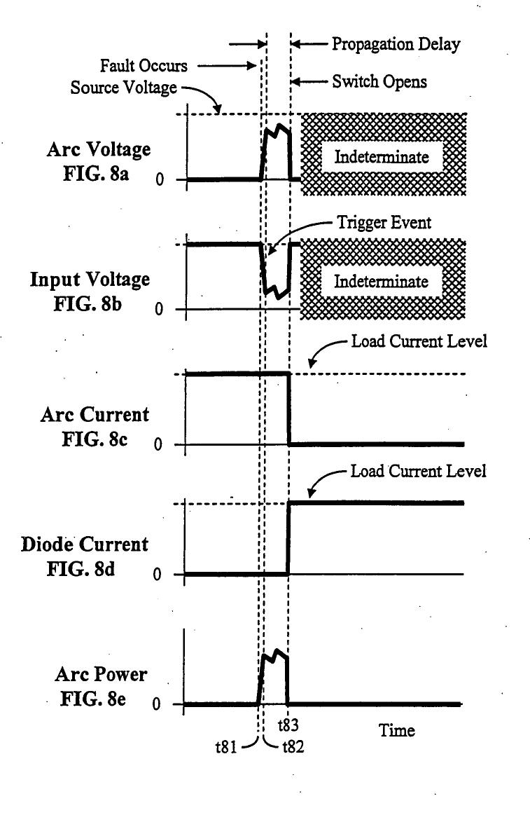

In the operation of the invention, the occurrence of an arcing fault in the interconnect wiring 10 of FIG. 3 is difficult to detect from the terminals of the power source 9. However, referring to FIG. 6, the initial rise in arc voltage FIG. 6a at time t61 is accompanied by a corresponding drop in input voltage to the load FIG. 6b. The fall and/or rate of fall of the load terminal voltage FIG. 6b at time t61 can be used to facilitate the transfer of current away from the arc. This concept is illustrated in FIG. 7. The enhancement device 21 is shown as a switch 22 with voltage sensitive detector 23 that responds to the fall and/or rate of fall of input voltage to the device. The input voltage to the device is the load input voltage. And more specifically the input voltage to the device is the voltage at the load end of the interconnect wiring 16 that is at risk of a potentially dangerous inline fault 18. The fall of or falling input voltage is detected by the voltage sense circuit 23. In response the switch 22 is opened. This action interrupts the overall load current path that feeds the arcing fault 18 and forces the current trapped in the inductive load 19 into the freewheeling diode 20. The transfer of current facilitated by the enhancement device is illustrated in the diagrams provided in FIG. 8. Given an arcing fault 18 that occurs at time t81, the arc voltage shown in FIG. 8a will appear at time t81 and increase abruptly. The arc voltage FIG. 8a increase at time t81 will result in a corresponding device input voltage FIG. 8b decrease at time t81. The voltage has fallen sufficiently to be detected by the voltage sensitive detector 23 at time t82 which triggers operation of the switch 22. The finite operation time or propagation delay spans from the time of detection at time t82 to the time at which the switch 22 opens at time t83. Upon opening switch 22 at time t83 the arc current FIG. 8c falls to zero and the current trapped in the inductive load 19 is transferred into the freewheeling diode 20. Also, the power FIG. 8e delivered to the arc 18 is forced to zero at time t83. The resulting energy, integration of power over time, delivered to the arc is limited.

This technique overcomes the voltage limiting characteristic of the arc in situations where the arc voltage could be below the source voltage level. In addition, this technique further takes advantage of the negative impedance and nonlinear characteristics of the arc. In fact, the arc voltage will rise as current is diverted away through the diode. This results in a further increase in arc voltage and accelerates the process of diverting current and extinguishing the arc.

Transient Suppression for Interconnect Wiring Inductance

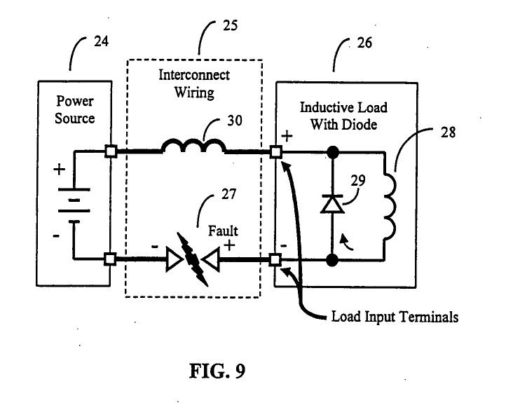

It is also important to consider the effects of the wiring inductance on the energy delivered to the fault. For analysis purposes the stray inductance may be lumped as shown in FIG. 9. The stray inductance exists throughout the interconnect circuitry 25. The lumped equivalent inductance 30 is shown as part of the interconnect wiring 25 connecting the power source 24 to the load 26. It is commonly believed that the energy trapped in the load 26 or more precisely the load inductance 28 is contained by the freewheeling diode 29 and that the energy trapped in the wiring inductance 30 is the only energy delivered to the fault 27. The expectation is that the energy delivered to the fault 27 includes and is limited to all of the energy trapped in the wiring inductance 30. In the events described given an arc or fault voltage drop that is lower than the source voltage the arc current will continue to flow. The stray inductance 30 and load inductance 28 act in unison to maintain the flow of current. In this case the power source 24 provides an indeterminate quantity of additional energy to the arcing fault 27.

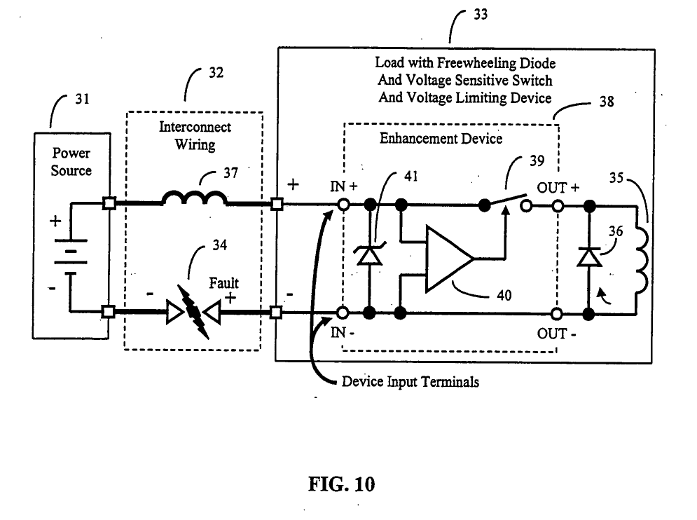

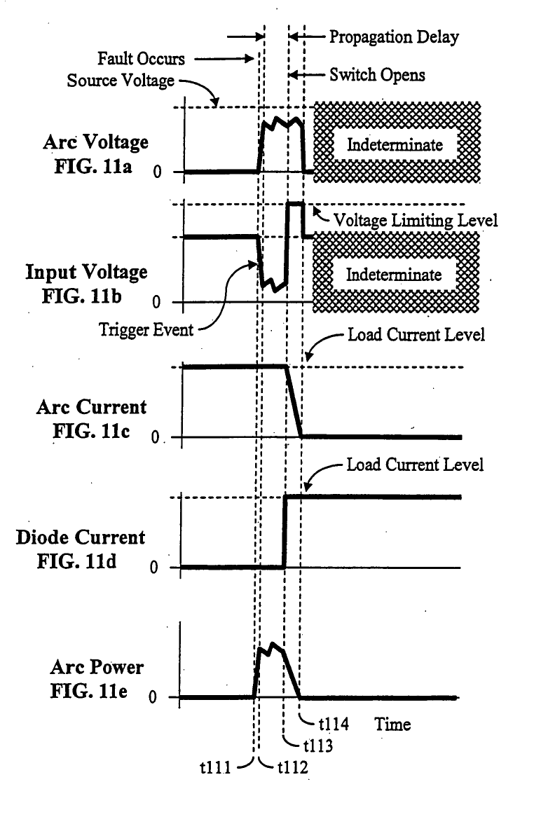

An artifact of the current interruption in the presence of stray wiring inductance is a voltage transient. FIG. 10 illustrates a technique to manage the voltage transient. A voltage liming device 41 connected across the input terminals of the enhancement device 38 limits the voltage transient. The voltage transient results from the opening of switch 39 when current is trapped in the stray wiring inductance 37. The transfer of current in the presence of stray wiring inductance with a voltage limiting device is illustrated in FIG. 11 with reference to FIG. 10. Given an arcing fault 34 that occurs at time t111 the arc voltage FIG. 11a will appear at time t111 and increase abruptly. The resulting decrease in input voltage FIG. 11b is detected by the voltage sense circuit 40 at time t112. After the operational or propagation delay spanning time t112 to time t113 switch 39 opens. The current trapped in the inductive load 35 is transferred into freewheeling diode 36. The freewheeling diode current is illustrated in FIG. 11d. However, current remains trapped in the stray line inductance 37. This current continues to flow through the power source 31, stray line inductance 37, arcing line fault 34 and voltage limiting device 41. The presence of the conducting voltage limiting device 41 at the input terminals of the enhancement device 38 determines the input terminal voltage FIG. 11b during the time period spanning time t113 to time t114. During this time period the arc current FIG. 11c is driven to zero. Recall that without the enhancement device 38 the arc current FIG. 11c could continue to flow for a substantially longer period of time. The result would be much higher energy, integration of arc power FIG. 11e over time, delivered to the arcing line fault 34.

Turn on Delay to Arrest Sputtering Faults

Intermittent faults or sputtering arcs require consideration. These conditions may allow the arc voltage to drop to zero or sufficiently low to cause the switch to reconnect the load device. If the switch reconnects the circuit and the conditions that caused the arc are still present the arc could re-strike. The energy can become additive to the previously delivered energy and result in an ignition.

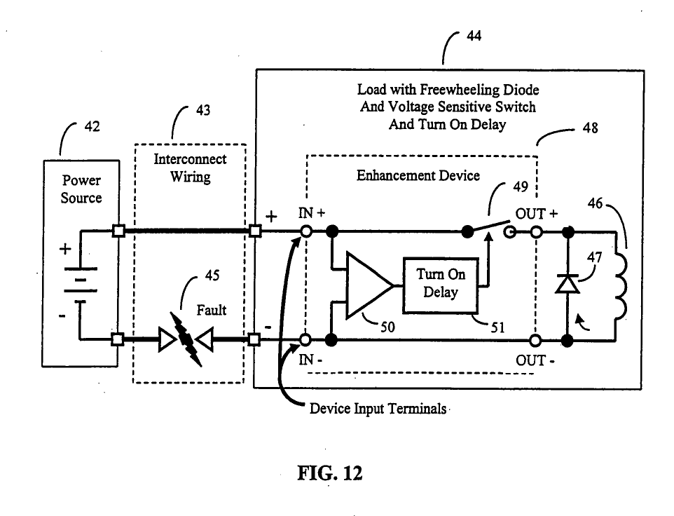

A solution to the potential of re-strike is to incorporate a turn on delay into the device as shown in FIG. 12. The turn-on delay 51 acts to delay the transition of the switch 49 from the off state to the on state after the input terminal voltage constraints of the enhancement device 48 are satisfied. The length of delay must be sufficient to clear or dissipate the energy from a previous arc. Ideally the turn off propagation delay of switch 49 in response to voltage sensor 50 will remain as short as possible.

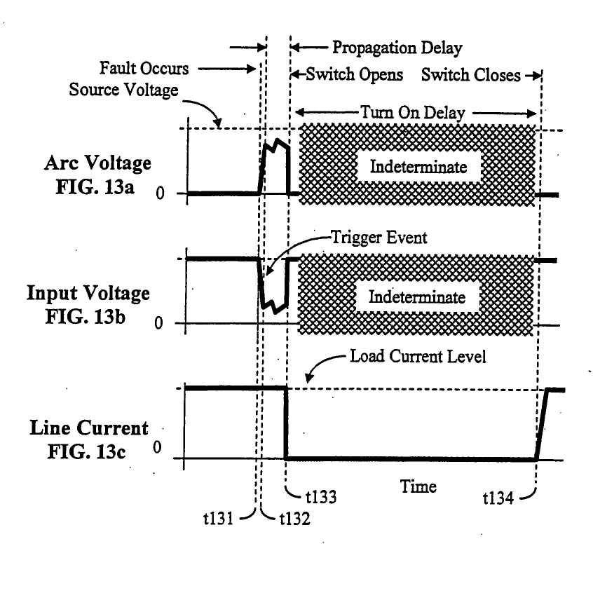

The turn on delay creates a period of time that the circuit remains open to prevent the arc from re-striking. The operational waveforms incorporating the delay are illustrated in FIG. 13. The sequence of events is as follows. The arcing fault 45 occurs at time t131. The resulting input voltage drop FIG. 13b is detected by the voltage sense circuit 50 at time t132. After the propagation delay spanning time t132 to time t133 the switch 49 opens. At this point in time the current trapped in the inductive load 46 transfers into the freewheeling diode 47. Also starting at time t133 the turn-on delay circuit 51 prevents the switch 49 from closing for the time period spanning time t133 to time t134.

Problem Scenario

It is possible to construct a system of intrinsically safe components that result in a system that is not intrinsically safe. A power source that is limited in current and voltage can achieve intrinsic safety ratings. Inductive loads that are protected by freewheeling diodes can also be applied to intrinsically safe systems. However, the diode protected inductive loads may be inadequate to pass intrinsic safety tests at the level of current that the power supply in combination with the other system components and wiring could otherwise reach safely. This anomaly is due to the previously discussed characteristics of the inductive load with freewheeling diode and the arcing fault.

Solution Scenario

A solution to the described problem is to segregate the system and employ a device that incorporates both upstream and downstream protection. The device is illustrated in FIG. 14. The primary elements of the device include the input transient suppression device 52, output clamping diode 53, detection circuit 54 and switch element 55.

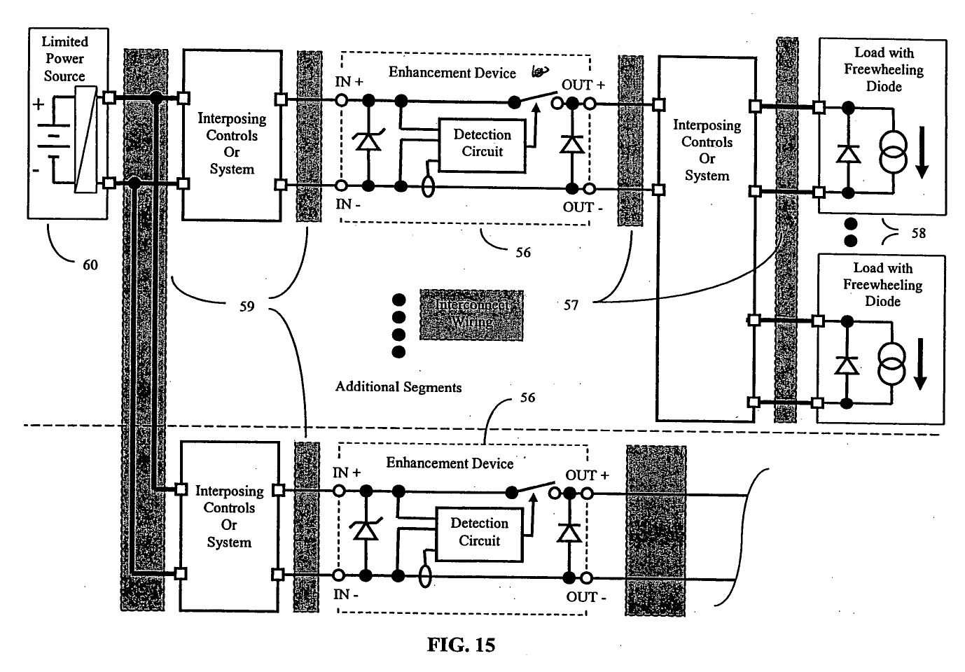

The segmented system with enhancement devices in each segment is shown in FIG. 15.

The system is separated into segments that are individually current limited by downstream protection in the enhancement devices 56 to a level to which intrinsic safety can be achieved. These downstream load branches 57 are feeding a load or loads 58 that are comprised partially or entirely of inductive loads clamped by freewheeling diodes.

Upstream protection is provided for the circuits 59 feeding each segment by each enhancement device 56. This maintains intrinsic safety in the presence of the total available current from the limited power supply 60 and the presence of the loads 58 that are comprised partially or entirely of inductive loads clamped by freewheeling diodes.

The wiring 59 between the power source 60 and the enhancement devices 56 is protected by the combination of the limited source 60 on the power delivery end and the enhancement device(s) 56 on the load end of the wiring 59. The wiring between the enhancement device 56 and the individual loads 58 is protected by a combination of the limited power source 60 and the further limited output of the enhancement device 56.

The segregated system may or may not include interposing controls or system components. In fact, the system will likely include both. For example, each downstream segment will likely include a number of freewheeling diode clamped inductive loads that collectively would far exceed the limited available current of the segment. However, the system functional constraints will dictate that the interposing controls may only energize a limited number of loads simultaneously to keep the total current of the segment below the current limit for that segment.

### PREFERRED EMBODIMENT

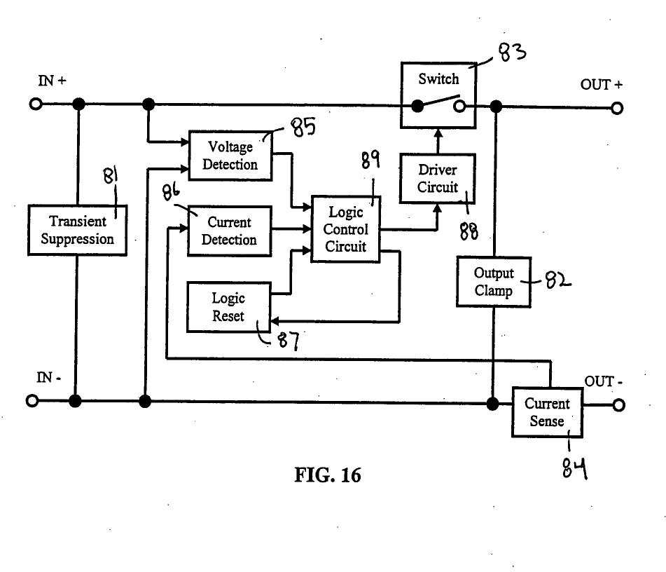

A functional block diagram of the enhancement device 56 is provided in FIG. 16. The primary power circuit functions are the input transient suppression 81, output clamping diode 82, the switch 83 and the current sense element 84. The internal functions of the detection circuit include input voltage monitor 85, output current monitor 86, logic power monitor/reset 87 and driver circuits 88 for the electronic switch 83.

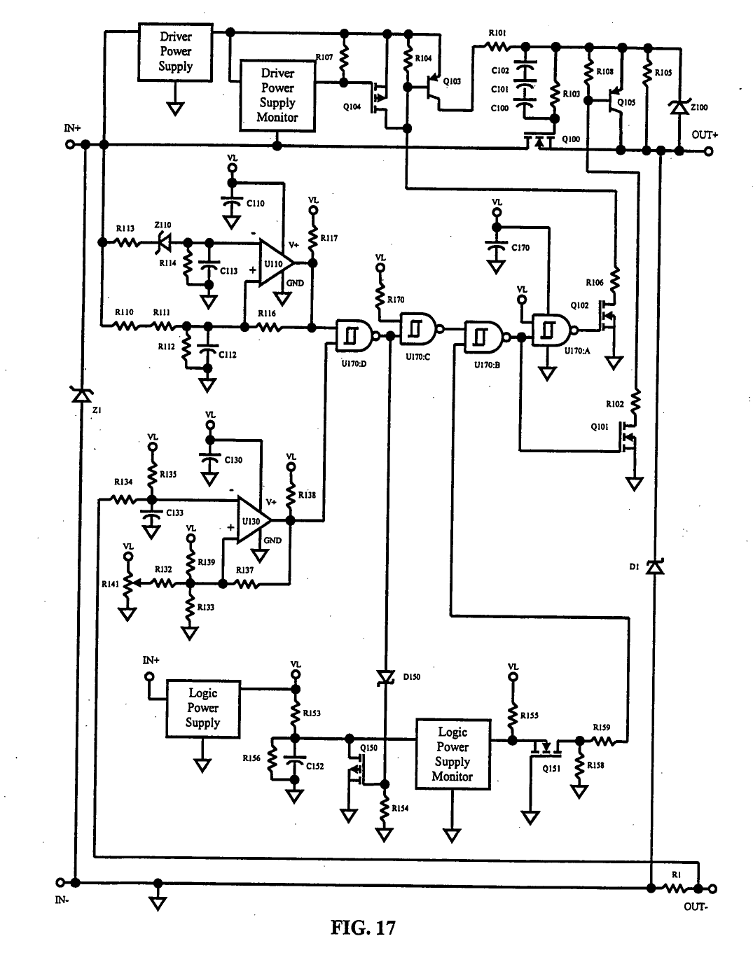

The detailed schematic for the enhancement device is provided in FIG. 17. The input transient suppression function is provided by zener diode Z1. The output clamping function is provided by diode D1. The switch element is transistor Q100. Resistor R1 is the current sense element.

The voltage detection circuit is comprised of comparator U110 and the peripheral components including R110, R111, R112, C112, R113, Z110, R114, C113, R116, R117 and C110. The input network of R110, R111, R112 and C112 provides direct feedback of the measured input terminal voltage to the enhancement device. The input network of R113, Z110, R114, and C113 provides an adaptive reference for the input voltage signal. Z110 sets this reference to a know level below the input terminal voltage. Filter capacitor C113 is sized to be a much larger or slower filter than that provided by C112. Therefore the reference level provided by C113 adapts slowly to changes in the applied terminal voltage while the input signal provided by C112 follow fast moving changes in the applied terminal voltage. C112 is intended to provide high frequency noise filtering.

The current detection circuit is comprised of comparator U130 and the peripheral components including R134, R135, C133, R141, R132, R139, R133, R137, R138 and C130. The input network of R134, R135 and C133 provides indirect feedback of the output current via the voltage across sense resistor R1. The input network of R141, R132, R139 and R133 provide the current limit reference setting.

The logic power supply provides power VL to the internal control circuits of the enhancement device. The power up delay and reset delay are provided by the network of R153, R156 and C152. The reset signal is coupled via D150 to activate Q150 to discharge C152 to start the timed charging of C152. The Logic Power Supply Monitor inhibits closing the main switch Q100 until the reset time is complete. This timing event is also experienced at power up when C152 would be initially discharged. The inhibit signal from the Logic Power Supply Monitor is coupled into the combinational control logic via R155, Q151, R158 and R159.

The combinational logic gates of U170 collect the voltage detection signal from U110, the current detection signal from U130 and the logic power and reset signal from R159. The result is the turn on and turn off commands for the main switch driver circuit.

There are two independents paths for turn off and turn on of the main switch. The turn off path is optimized for very fast turn off. The turn off signal is coupled via Q101 and R102 to Q105. Q105 clamps and pulls away the on drive for the main switch transistor Q100. The turn on signal is coupled via Q102 and R106 to Q103. Q103 provides on drive to Q100 via R101, R103, C100, C101 and C102. The on drive signal is inhibited from activating Q103 by Q104 if the Driver Power Supply Monitor detects inadequate voltage from the Driver Power Supply.

Redundant Implementation

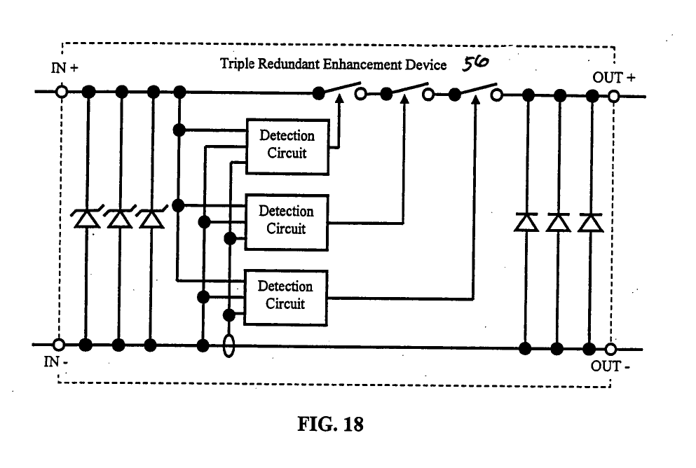

In safety related applications the enhancement device 56 may be required to be redundant or triply redundant. FIG. 18 illustrates a triple redundant implementation in block diagram format.

Addressing Multiple Ground Faults

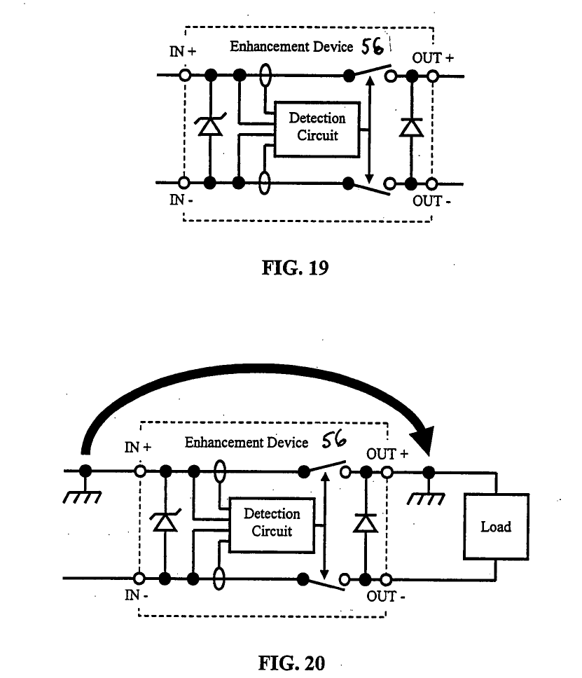

In some applications the power source may be entirely isolated from earth ground. In such cases multiple ground faults could exist within the overall system and effectively bypass the protection provided by the device 56. Protection from multiple ground faults can be achieved by providing additional capability in the enhancement device 56. FIG. 19 illustrates a variation of the enhancement device 56 with current sensing and switch in both the positive and negative current paths. As shown in FIG. 20, the ground faults effectively bypass the protection in the positive current path of the device. However, in the implementation shown, full current path protection is also provided in the negative current path.

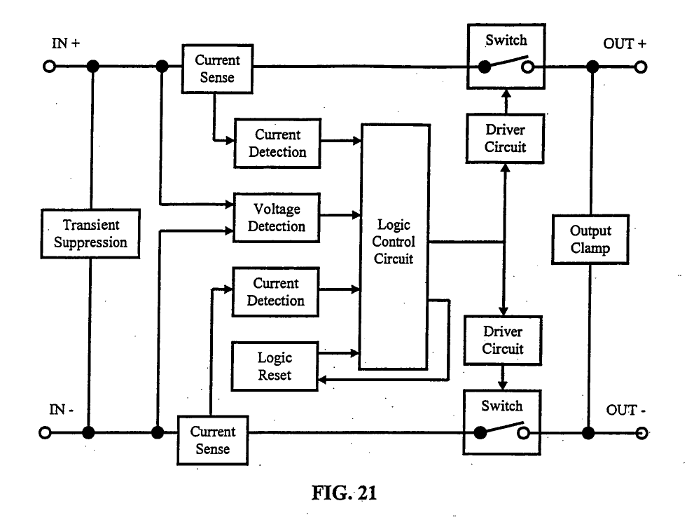

A more detailed block diagram of the enhancement device 56 with current sensing and switch in both the positive and negative current paths is provided in FIG. 21. In this implementation, the switches respond in tandem. In addition to an over current condition in either current path the switches are opened or disconnected in response to any of the previously described fault conditions. Either switch is capable of providing protection under normal circumstances. However, the presence and operation of both switches ensures that the existence of multiple ground faults in either path do not defeat the protection scheme.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. An intrinsically safe system in a hazardous atmosphere comprising:
a power supply;
a plurality of load devices;
wiring in communication with the power supply and the load devices that is located in the hazardous atmosphere; and
enhancement device connected to the wiring which provides upstream protection by detecting dropping input terminal voltage and provides downstream protection by limiting output current.

2. A system as described in claim 1 wherein the plurality of load devices are arranged into segments, and the protector provides downstream protection to a specific segment by limiting output current.

3. A system as described in claim 2 wherein the plurality of load devices incorporate freewheeling diodes to contain trapped inductive load energy.

4. A system as described in claim 3 wherein the enhancement device includes an integral switch to interrupt a current delivery path from the input terminals of the enhancement device to the output terminals of the enhancement device.

5. A system as described in claim 4 wherein the switch is electronic.

6. A system as described in claim 5 wherein the switch is a MOSFET transistor.

7. A system as described in claim 6 wherein the switch is controlled in response to a combination of conditions including input terminal voltage to the enhancement device, output current delivered by the enhancement device and internal logic power voltage levels.

8. A system as described in claim 7 wherein the switch is inhibited from turning on if its internal logic power levels are above a predetermined level.

9. A system as described in claim 8 wherein the enhancement device includes a switch control circuit that delays the turn on of the switch at power up and after the switch has been turned off in response to a fault condition.

10. A system as described in claim 9 including a voltage detector to monitor input terminal voltage to the enhancement device to observe a drop are dropping input terminal voltage, and in response, the enhancement device interrupts the current delivery path to its output terminals preferably.

11. A system as described in claim 10 wherein the enhancement device includes a voltage detector that is adapted to maintain a detection level at a specified value below a nominal input terminal voltage of the enhancement device, the detection level is maintained in response to slowly changing input terminal voltage to the enhancement device.

12. A system as described in claim 11 wherein the enhancement device includes a current level detector to monitor the output current from the enhancement device to observe a current that attempts to exceed a predetermined level, and in response, the enhancement device interrupts the current delivery path to its output terminals.

13. A system as described in claim 12 wherein the system includes a second enhancement device for redundancy.

14. A system as described in claim 13 wherein the system includes a third enhancement device for triple redundancy.

15. A method for providing power in a hazardous atmosphere comprising the steps of:
placing wiring in communication with a power supply and a plurality of load devices to the hazardous atmosphere; and
protecting the wiring with a protector connected to the wiring which provides upstream protection by detecting dropping input terminal voltage and provides downstream protection by limiting output current.

16. A method as described in claim 15 including the step of locating the protector inside a mine.
